(19) United States
(12) Patent Application Publication
(10) Pub. No.: US 2007/0121184 A1
(43) Pub. Date: May 31, 2007

(54) Holographic storage device

(75) Inventors: Willem Marie Julia Marcel Coene, Eindhoven (NL); Sjoerd Stallinga, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/581,635

(22) PCT Filed: Nov. 26, 2004
(86) PCT No.: PCT/IB04/03916

§ 371 Date: Jun. 5, 2006

(30) Foreign Application Priority Data
Dec. 8, 2003 (EP) 03078841.8
Aug. 19, 2004 (EP) 04300549.5

(51) Int. Cl. G03H 1/26

(52) U.S. Cl. 359/22

(57) ABSTRACT

The invention relates to an optical holographic device for recording a data page in a holographic medium (106). The device comprises means (100) for generating a signal beam, means (201) for modulating the phase of the signal beam so as to encode the data page and means (102, 107, 108) for interfering the modulated signal beam with a reference beam inside the holographic medium. The invention also relates to a corresponding holographic read-out device, to a method for reading out a phase-modulated data page and to a holographic medium comprising at least one phase-modulated data page.

### FIELD OF THE INVENTION

The present invention relates to an optical holographic device for recording in and/or reading out a data page from a holographic medium, to a holographic medium, to a method for reading out such a data page and to a computer program for carrying out such a method.

### BACKGROUND OF THE INVENTION

An optical device capable of recording on and reading from a holographic medium is known from H. J. Coufal, D. Psaltis, G. T. Sincerbox (Eds.), ‘Holographic data storage’, Springer series in optical sciences, (2000). FIG. 1 shows such an optical device. This optical device comprises a radiation source 100, a collimator 101, a first beam splitter 102, a spatial light modulator 103, a second beam splitter 104, a lens 105, a first deflector 107, a first telescope 108, a first mirror 109, a half wave plate 110, a second mirror 111, a second deflector 112, a second telescope 113 and a detector 114. The optical device is intended to record in and read data from a holographic medium 106.

During recording of a data page in the holographic medium, half of the radiation beam generated by the radiation source 100 is sent towards the spatial light modulator 103 by means of the first beam splitter 102. This portion of the radiation beam is called the signal beam. Half of the radiation beam generated by the radiation source 100 is deflected towards the telescope 108 by means of the first deflector 107. This portion of the radiation beam is called the reference beam. The signal beam is spatially modulated by means of the spatial light modulator 103. The spatial light modulator comprises transmissive areas and absorbent areas, which corresponds to zero and one data-bits of a data page to be recorded. After the signal beam has passed through the spatial light modulator 103, it carries the signal to be recorded in the holographic medium 106, i.e. the data page to be recorded. The signal beam is then focused on the holographic medium 106 by means of the lens 105.

The reference beam is also focused on the holographic medium 106 by means of the first telescope 108. The data page is thus recorded in the holographic medium 106, in the form of an interference pattern as a result of interference between the signal beam and the reference beam. Once a data page has been recorded in the holographic medium 106, another data page is recorded at a same location of the holographic medium 106. To this end, data corresponding to this data page is sent to the spatial light modulator 103. The first deflector 107 is rotated so that the angle of the reference signal with respect to the holographic medium 106 is modified. The first telescope 108 is used to keep the reference beam at the same position while rotating. An interference pattern is thus recorded with a different pattern at a same location of the holographic medium 106. This is called angle multiplexing. A same location of the holographic medium 106 where a plurality of data pages is recorded is called a book.

Alternatively, the wavelength of the radiation beam may be tuned in order to record different data pages in a same book. This is called wavelength multiplexing. Other kinds of multiplexing, such as shift multiplexing or phase-encoded multiplexing, may also be used for recording data pages in the holographic medium 106. In phase-encoded multiplexing, the phase of the reference beam is varied so as to record different data pages.

During readout of a data page from the holographic medium 106, the spatial light modulator 103 is made completely absorbent, so that no portion of the beam can pass trough the spatial light modulator 103. The first deflector 107 is removed, such that the portion of the beam generated by the radiation source 100 that passes through the beam splitter 102 reaches the second deflector 112 via the first mirror 109, the half wave plate 110 and the second mirror 111. If angle multiplexing has been used for recording the data pages in the holographic medium 106, and a given data page is to be read out, the second deflector 112 is arranged in such a way that its angle with respect to the holographic medium 106 is the same as the angle that was used for recording this given hologram. The signal that is deflected by the second deflector 112 and focused in the holographic medium 106 by means of the second telescope 113 is thus the phase conjugate of the reference signal that were used for recording this given hologram. If for instance wavelength multiplexing has been used for recording the data pages in the holographic medium 106, and a given data page is to be read out, the same wavelength is used for reading this given data page.

The phase conjugate of the reference signal is then diffracted by the information pattern, which creates a reconstructed signal beam, which then reaches the detector 114 via the lens 105 and the second beam splitter 104. An imaged data page is thus created on the detector 114, and detected by said detector 114. The detector 114 comprises pixels or detector elements, each detector element corresponding to a bit of the imaged data page.

In the known prior art, the data pages are thus encoded in that the amplitude of the signal beam is modulated.

### SUMMARY OF THE INVENTION

It is an object of the invention to provide a holographic device for recording a data page in a holographic medium, the device being an alternative to the known solutions.

To this end, the invention proposes an optical holographic device for recording a data page in a holographic medium, said device comprising means for generating a signal beam, means for modulating the phase of said signal beam so as to encode said data page and means for interfering said modulated signal beam with a reference beam inside said holographic medium.

Advantageously, the holographic device further comprises means for modulating the amplitude of the signal beam. This is particularly advantageous, because it increases the data density that can be recorded in the holographic medium. Actually, for a given multiplexing parameter, such as a given angle or a given wavelength, two data pages may be recorded at a same location of the recording medium. One of the data pages is phase-modulated and the other data page is amplitude-modulated. The data density is thus increased with respect to the prior art, where only one data page can be recorded at a given location of the holographic medium for a given multiplexing parameter.

The invention also relates to a holographic medium comprising at least one phase-modulated data page. Advantageously, the holographic medium further comprises at least one amplitude-modulated data page.

The invention further relates to a holographic device for reading out such a holographic medium, said holographic device comprising means for retrieving phases of individual data bits of the phase-modulated data page.

Advantageously, the device comprises means for generating a reference signal, means for directing said reference signal towards said holographic medium so as to generate a phase-modulated reconstructed signal beam, means for detecting said phase-modulated signal beam, means for generating a probe signal and means for interfering said probe signal with the phase-modulated reconstructed signal beam before the latter reaches the detecting means. Interference of the phase-modulated reconstructed signal beam with a probe signal allows detecting the phases of individual data bits of the phase-modulated data page via the interference pattern that is recorded as a 2D signal or image on a conventional detector such as a CCD.

In a first embodiment, the holographic device comprises means for calculating a Fourier transform of a signal detected on the detecting means, said Fourier transform comprising a central band and two side-bands, and means for calculating a backward Fourier transform of at least one of the side-bands so as to retrieve phases of individual data bits of the phase-modulated data page.

In a second embodiment, the holographic device comprises means for varying the phase of said probe signal so as to retrieve the phases of individual data bits of the phase-modulated data page by means of a phase stepping procedure. In this embodiment, the amount of required signal processing is low, and hence the power consumption is low and the speed of data retrieval is high.

The invention further relates to a method for reading out a such a holographic medium, said method comprising a step of retrieving phases of individual data bits of the phase-modulated data page.

The invention further relates to a computer program comprising a set of instructions which, when loaded into a processor or a computer, causes the processor or the computer to carry out this method.

These and other aspects of the invention will be apparent from and will be elucidated with reference to the embodiments described hereinafter.

### BRIEF DESCRIPTION OF THE DRAWINGS

The invention will now be described in more detail by way of example with reference to the accompanying drawings, in which:

FIG. 1 shows a holographic device in accordance with the prior art;

FIGS. 2a and 2b show a holographic recording device in accordance with the invention;

FIG. 3 shows a holographic recording device in accordance with an advantageous embodiment of the invention;

FIG. 4 shows a holographic read-out device in accordance with the invention;

FIG. 5 illustrates a method for reading out a data page in accordance with a first embodiment of the invention;

FIG. 6 illustrates another method for reading out a data page in accordance with a first embodiment of the invention.

### DETAILED DESCRIPTION OF THE INVENTION

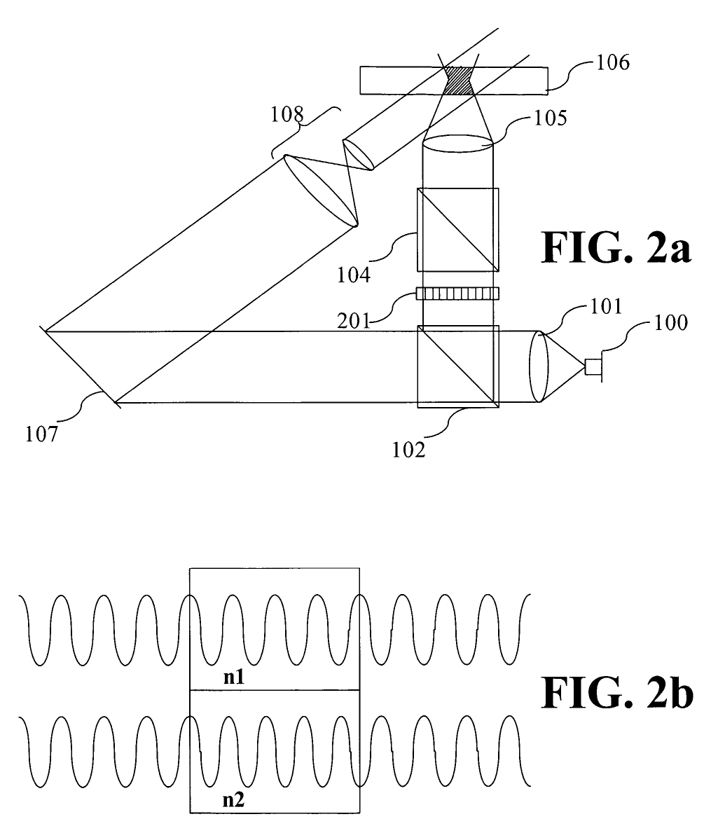

FIG. 2 shows a holographic recording device in accordance with the invention. The holographic device comprises the radiation source 100, the collimator 101, the first beam splitter 102, a phase modulation spatial light modulator 201, the second beam splitter 104, the lens 105, the first deflector 107 and the first telescope 108. The holographic device is intended to record data in the holographic medium 106.

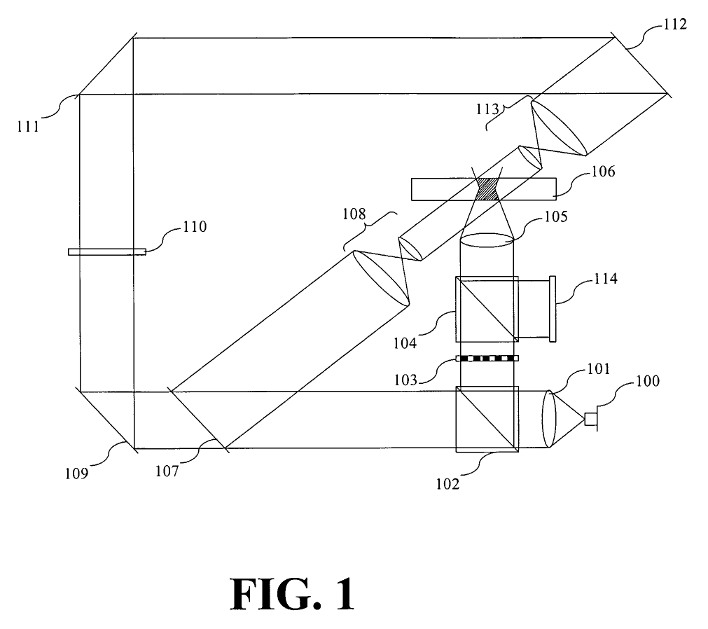

The recording of a data page in the holographic medium 106 is similar to the recording described in FIG. 1. However, the signal beam is modulated in phase instead of being modulated in amplitude. To this end, the amplitude modulation spatial light modulator 103 of FIG. 1 is replaced by the phase modulation spatial light modulator 201. The phase modulation spatial light modulator 201 comprises an array of modulation elements. At least some modulation elements are adapted for modifying the phase of the portion of the signal beam that passes through these modulation elements.

In FIG. 2b, two modulation elements of the phase modulation spatial light modulator 201 are represented. A first modulation element has a first refractive index n1 and a second modulation element a second refractive index n2, where n1 is different from n2. In the example of FIG. 2b, the first refractive index n1 is such that the propagation of the portion of the radiation beam that passes through the first modulation element is not modified by said first modulation element. The second refractive index n2 is such that the propagation of the portion of the radiation beam that passes through the second modulation element is modified by said second modulation element. In other words, the first and second refractive index n1 and n2, respectively, are such that a phase difference between the two portions of the radiation beam exiting the spatial light modulator is created. In the example of FIG. 2b, a phase difference of n is created between these two portions of the radiation beam behind the phase modulation spatial light modulator 201. How this phase difference may be detected in a holographic read-out device is described later on.

It is thus possible to encode a data page by means of the phase modulation spatial light modulator 201. The phase modulation spatial light modulator 201 may generate only two different phases, such as 0 and π, but may also generate more than two different phases. To this end, the refractive indices of the modulation elements of the phase modulation spatial light modulator 201 can take more than two different values. An example of phase modulation spatial light modulator 201 is a liquid crystal device comprising an array of liquid crystal pixels, such as 1000*1000 pixels. The refractive index of each pixel may be controlled by a voltage applied between electrodes in each pixel. A data page is sent to the phase modulation spatial light modulator 201 and the suitable voltages are applied to the liquid crystal pixels so as to encode the data page in the signal beam.

Examples of such a phase modulation spatial light modulator are described in G. D. Love, “Liquid Crystal Adaptive Optics” in “Adaptive Optics Engineering Handbook” (R. K. Tyson, editor), (Marcel Dekker, New York, 2000). Such a phase modulation spatial light modulator is also described in patent application WO0248800, which relates to a holographic device using a phase modulation spatial light modulator. However, the phase modulation spatial light modulator is placed in the reference branch, and the phase of the reference signal is encoded. The purpose of this phase modulation spatial light modulator is thus to allow for phase-encoded multiplexing.

In the example of FIG. 2a, angle multiplexing is used for recording different data pages at a same location of the holographic medium 106. However, other kinds of multiplexing may be used without departing from the scope of the invention.

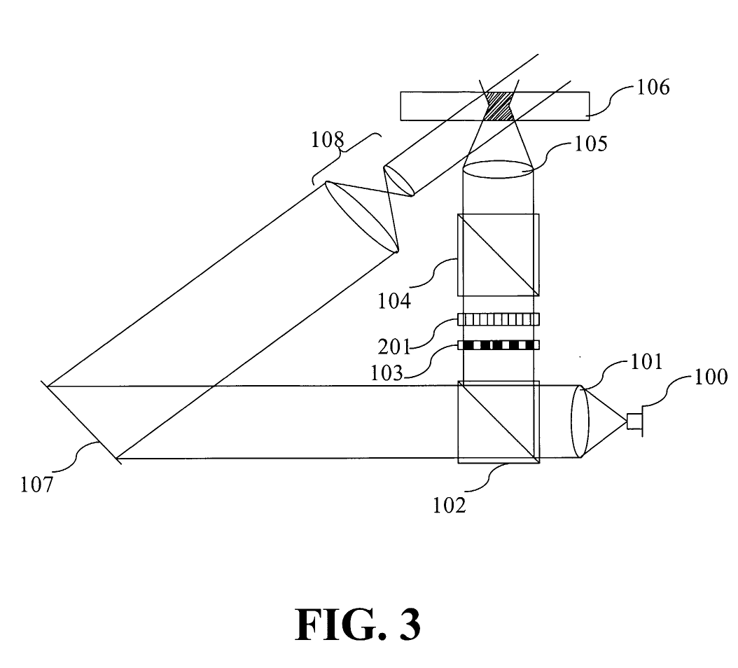

FIG. 3 illustrates another holographic recording device in accordance with the invention. This holographic device comprises the same elements as the holographic device of FIG. 2, except that it further comprises the amplitude modulation spatial light modulator 103. The signal beam is thus modulated in phase and in amplitude. This allows recording two data pages at a same location of the holographic medium 106 with a same multiplexing parameter. Actually, the signal beam that interferes with the reference beam in the holographic medium 106 for recording data comprises amplitude information and phase information. As will be explained later on, it is possible to independently retrieve the phase information and the amplitude information. Hence, it is possible to record twice as much information as in the prior art at a same location of the recording medium 106. This can be seen as recording two data pages where only one data page can be recorded in the prior art, or recording a single data page with twice as much information as a data page of the prior art.

It should be noted that the phase modulation spatial light modulator 201 and the amplitude modulation spatial light modulator 103 may form part of one and the same modulation component. Such a modulation component comprises for instance two superposed arrays of modulation elements, one for the phase modulation and the other one for the amplitude modulation. This has the advantage that there is no need to align the phase modulation spatial light modulator 201 and the amplitude modulation spatial light modulator 103, as they are already aligned in said modulation component.

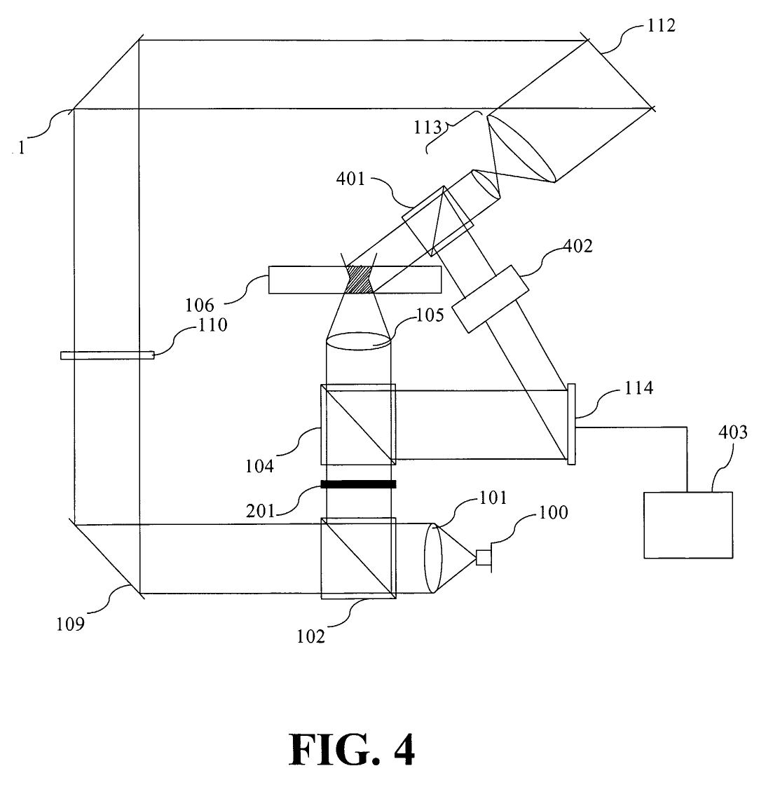

FIG. 4 illustrates a holographic read-out device in accordance with the invention. This optical device comprises the radiation source 100, the collimator 101, the first beam splitter 102, the phase modulation spatial light modulator 201, the second beam splitter 104, the lens 105, the first mirror 109, the half wave plate 110, the second mirror 111, the second deflector 112, the second telescope 113, the detector 114, a third beam splitter 401, deflection means such as a grating 402 and a processing circuit 403. This optical device is intended to read data from the holographic medium 106.

The read-out of a data page is similar to the read-out described in FIG. 1, except that a probe signal is generated by means of the third beam splitter 401 and directed towards the detector 114 by means of the grating 402 so as to interfere with the reconstructed signal beam before the latter reaches the detector 114.

During read-out, the signal beam generated by means of the first beam splitter 102 is blocked by the phase modulation spatial light modulator 201 in that suitable voltages are applied to the pixels of said phase modulation spatial light modulator 201. Alternatively, another optical component may be added in the holographic device instead of the phase modulation spatial light modulator 201, which optical component is opaque. This can be the case if the holographic device is a read-only device. If the holographic device is intended to record and read data in accordance with the invention, an additional component may be placed in the holographic device, which component can be transparent during recording and opaque during read-out. This may be the case of a plate comprising an electrochromic material between two electrodes. The phase modulation spatial light modulator 201 may also comprise an additional electrochromic layer, which can be made opaque during read-out by application of a suitable potential difference between two transparent electrodes.

During read-out with a given multiplexing parameter, a reconstructed signal beam is generated, which corresponds to the data page recorded with said multiplexing parameter. The wavefront of the reconstructed signal beam equals the wavefront of the phase modulation spatial light modulator 201 that was used for recording said data page. The wavefront of the reconstructed signal beam will thus be denoted Ψ^{j}_{SLM}, where j corresponds to the multiplexing parameter. The multiplexing parameter j can be for instance the angle of the reference beam used for recording a given data page, although the invention applies equally to other kind of multiplexing.

The probe signal beam has a plane wave wavefront with a vector denoted K_{probe}. This wavefront is denoted Ψ_{probe} The vector K_{probe} depends on the grating 402. The choice of the vector K_{probe}, which depends on the deflection angle of the grating 402, will be discussed later on. As the reconstructed signal beam and the probe signal beam interfere before reaching the detector 114, this gives rise to a detected signal beam, which wavefront is the sum of the wavefronts of the reconstructed signal beam and the probe signal beam, i.e. Ψ^{j}_{CCD}=Ψ^{j}_{SLM}+Ψ_{probe}, where Ψ^{j}_{CCD} denotes the wavefront of the detected signal beam. The detector 114 is sensitive only to the power in the optical wavefront, that is, |Ψ^{j}_{CCD}|².

The wavefront of the detected signal beam can thus be written Ψ^{j}_{CCD}(R)=Ψ^{j}_{SLM}(R)+exp(2πiK_{probe}.R)exp(iφ), where R represents the 2D position coordinates in the plane of the phase modulation spatial light modulator 201 and φ represents a phase difference between the reconstructed signal beam and the probe signal beam, due to possible non-equal distances for the light paths of these beams.

The detector 114 only records the intensity of the detected signal beam, i.e

$$\begin{matrix}{I}_{CCD}^{j} ( R ) = {\vert {ψ}_{CCD}^{j} ( R ) \vert}^{2} \\ = 1 + {\vert {ψ}_{SLM}^{j} ( R ) \vert}^{2} + {ψ}_{SLM}^{j} ( R ) exp ( - 2 π ⅈ {K}_{probe} . R ) exp ( - ⅈ ϕ ) + \\ {{ψ}_{SLM}^{j} ( R )}^{*} exp ( 2 π ⅈ {K}_{probe} . R ) exp ( ⅈ ϕ )\end{matrix}$$

The methods described hereinafter give different examples that can be implemented by the processing circuit 403 for retrieving the phases of Ψ^{j}_{SLM}(R) from the intensities recorded on the detector 114. The phases of the individual data bits recorded in the holographic medium 106 are equal to the phases of Ψ^{j}_{SLM}(R)), up to a constant phase-shift that cannot be detected but is irrelevant.

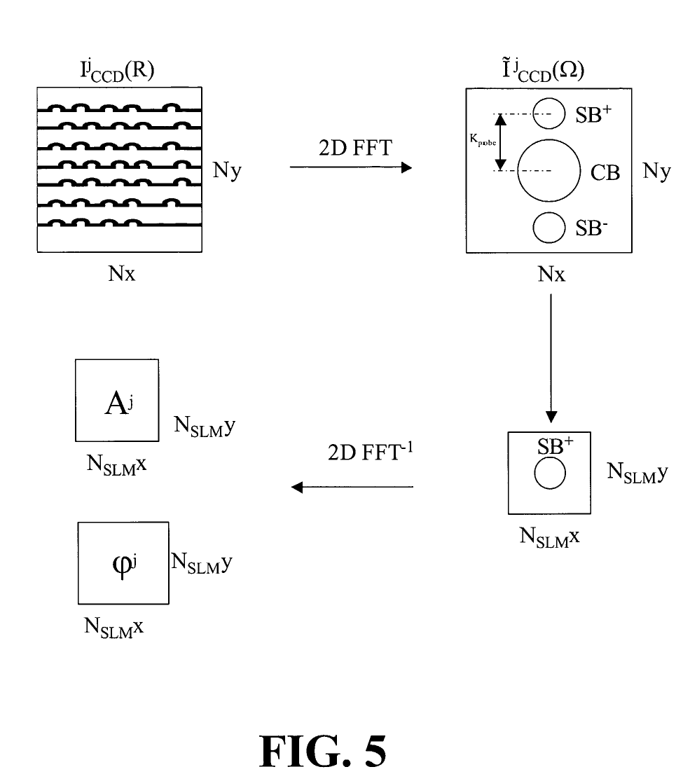

FIG. 5 shows a first embodiment for retrieving the phases of the individual data bits of a phase-modulated data page. The intensity on the detector 114 is shown as I^{j}_{CCD}(R). If the phase of the reconstructed signal beam was constant, the intensity on the detector 114 would comprise fringes, which orientation would be perpendicular to the vector K_{probe}. As the phase of the reconstructed signal beam is not constant, the intensity on the detector 114 comprises fringes which are modulated by the phases of the individual data bits of the data page. As a consequence, the number Nx*Ny of pixels of the detector 114 is chosen higher than the number N_{SLM}x*N_{SLM}y of modulation elements of the phase modulation spatial light modulator 201, so as to be able to detect these phase-modulated fringes. More precisely, the number of pixels of the detector 114 is higher than the number of modulation elements of the phase modulation spatial light modulator 201 in the direction parallel to the probe vector K_{probe}. In this example, Ny is larger than N_{SLM}y. This can be achieved in that the detector 114 comprises rectangular pixels, with a size in the direction of K_{probe} smaller than the size in the direction perpendicular to K_{probe}.

A first step of the method consists in a Fourier transform of the signal detected on the detector 114, i.e. a Fourier transform of I^{j}_{CCD}(R). The Fourier transform Ĩ^{j}_{CCD}(Ω) of I^{j}_{CCD}(R) can be written Ĩ^{j}_{CCD}(Ω)=FT_{R→Ω}{I^{j}_{CCD}(R)}=CB(Ω)+SB⁺(Ω)+SB⁻(Ω), where CB represents the central band and SB each of the two side-bands in the Fourier transform of I^{j}_{CCD}(R). The central band CB(Ω) corresponds to the Fourier transform of 1+|Ψ^{j}_{SLM}(R)|², and thus comprises information about the amplitude of the wavefront of the reconstructed signal beam. The side-bands SB⁺(Ω) and SB⁻(Ω) respectively correspond to the Fourier transforms Of Ψ^{j}_{SLM}(R)exp(−2πiK_{probe}.R)exp(−iφ) and Ψ^{j}_{SLM}(R)*exp(2πiK_{probe}. R)exp(iφ).

It should be noted that the band-width of the central band CB(Ω) is at maximum twice as large as the band-width of the side-bands SB⁺(Ω) and SB⁻(Ω). The distance in the Fourier spectrum between the central band CB(Ω) and the side-bands SB⁺(Ω) and SB⁻(Ω) equals the magnitude of the probe vector K_{probe}. Hence, the magnitude of the probe vector K_{probe} is chosen in such a way that the central band CB(Ω) and the side-bands SB⁺(Ω) and SB⁻(Ω) do not overlap in the Fourier spectrum.

The side-bands SB⁺(Ω) and SB⁻(Ω) are each other's complex conjugates, since they result from the 2D Fourier transform of a real-valued image. As a consequence, they carry exactly the same information. The second step of the method comprises a selection of one of the side-bands, such as SB⁺(Ω). Then, the selected side-band is preferably centered with respect to its center point, i.e. the value SB⁺(Ω-K_{probe}) is calculated.

The third step of the method consists in calculating the backward Fourier transform of SB⁺(Ω-K_{probe}). This allows retrieving the wavefront of the reconstructed signal beam:
Ψ^{j}_{SLM}(R)=FT_{Ω→R}{SB⁺(Ω-K_{probe})}

This quantity contains both amplitude and phase information of the wavefront of the reconstructed signal beam. In the example of FIG. 5, only the phase of the signal beam is modulated. This method allows retrieving the phases of the individual data bits of the data page recorded with the multiplexing parameter j. If the amplitude of the signal beam is also modulated, this method also allows retrieving the amplitudes of the individual data bits of the data page recorded with the multiplexing parameter j.

It should be noted that the information of the central band CB(Ω) may also be processed in order to retrieve the amplitudes of the individual data bits of the data page recorded with the multiplexing parameter j. This may be useful when the signal-to-noise ratio is low, so that it can advantageously be combined with the amplitude information obtained by processing the information of the side-band SB⁺(Ω). To this end, the central band CB(Ω) is selected and the backward Fourier transform of CB(Ω) is calculated.

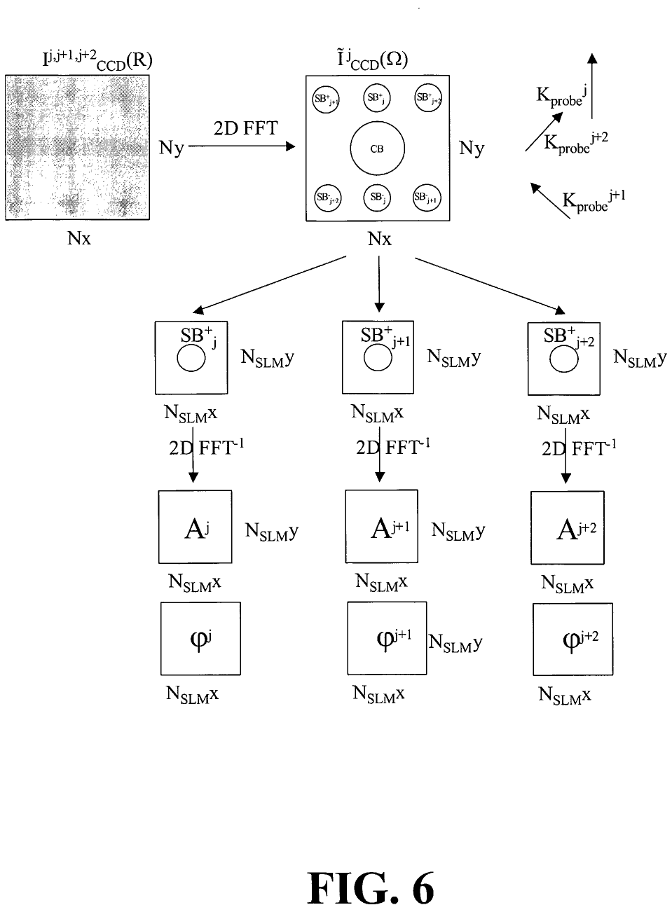

FIG. 6 shows another embodiment for reading out a data page in accordance with the invention. In this embodiment, a plurality of data pages are detected on the detector 114, each with a different probe vector. In the example of FIG. 6, three different probe vectors are used for detecting three consecutive data pages of the holographic medium 106. The reference signal used for reconstructing the data page recorded with the multiplexing parameter j is interfered with a first probe vector K_{probe}^{j}, and the resulting signal is detected on the detector 114. The reference signal used for reconstructing the data page recorded with the multiplexing parameter j+1 is interfered with a second probe vector K_{probe}^{j+1}, and the resulting signal is also detected on the detector 114. This means that these two signals are added on the detector 114. The same is performed with the multiplexing parameter j+2, where a third probe vector K_{probe}^{j+2} is used. The directions of the three probe vectors differ from each other.

Then, a Fourier transform of the signal detected on the detector 114 is performed. The resulting Fourier transform comprises a central band CB(Ω) and six side-bands SB⁺ⱼ(Ω), SB⁻_{j(Ω), SB}⁺ⱼ₊₁(Ω), SB⁻ⱼ₊₁(Ω), SB⁺ⱼ₊₂(Ω) and SB⁻ⱼ₊₂(Ω). Then, the side-bands SB⁺ⱼ(Ω), SB⁺ⱼ₊₁(Ω), and SB⁺ⱼ₊₂(Ω) are selected, and a backward Fourier transform of these side-bands is performed, preferably after a centering operation as described in FIG. 5. This allows retrieving the amplitudes and phase information about the three data pages that had been recorded respectively with the multiplexing parameters j, j+1 and j+2.

This embodiment is advantageous, because it decreases the required processing necessary for retrieving the amplitude and phase information. Actually, only one forward Fourier transform is needed in the first step of the method. The forward Fourier transform is the most complex one, since it is carried out over the complete field of view of the detector 114.

Other methods may be used for retrieving the phases of the individual data bits of a phase-modulated data page. Another example is described hereinafter, based on the holographic read-out device of FIG. 4. This method uses a phase stepping procedure. In the example described hereinafter, the phases of the individual data bits can only be 0 or π.

In this method, the probe signal beam has a uniform wavefront, i.e. the probe vector K_{probe} is a null vector. As a consequence, the intensity on the detector 114 is
I^{j}_{CCD}(R)=1+|Ψ^{j}_{SLM}(R)|²+2|Ψ^{j}_{SLM}(R)|cos(φ_{SLM}(R)−φ),

where φ_{SLM}(R) is the phase of the wavefront Ψ^{j}_{SLM}(R) that is to be retrieved. The phase stepping procedure consists in varying the phase φ and measuring the intensity I^{j,φ}_{CCD}(R) for different values of φ. In this example, only two values of φ are required. The phase φ may be varied by changing the optical path of the probe signal beam, for example by displacing a mirror placed between the third beam splitter 402 and the detector 114. In this example, a first phase φ₁ is chosen such that φ₁≠(2n+1)π/2. A second phase φ₂ is chosen such that φ₂₋φ₁=π. After detection of I^{j,φ1}_{CCD}(R) and I^{j,φ2}_{CCD}(R), the value I^{j,φ1}_{CCD}(R)−I^{j,φ2}_{CCD}(R) is measured for each R:

$${I}_{CCD}^{j , ϕ 1} ( R ) - {I}_{CCD}^{j , ϕ 2} ( R ) = 4 \vert {ψ}_{SLM}^{j} ( R ) \vert cos ( {φ}_{SLM} ( R ) - {ϕ}_{1} )$$

$$\begin{matrix}Hence , & {I}_{CCD}^{j , ϕ 1} ( R ) - {I}_{CCD}^{j , ϕ 2} ( R ) = 4 \vert {ψ}_{SLM}^{j} ( R ) \vert cos ( {ϕ}_{1} ) & if {φ}_{SLM} ( R ) = 0 and \\ & {I}_{CCD}^{j , ϕ 1} ( R ) - {I}_{CCD}^{j , ϕ 2} ( R ) = - 4 \vert {ψ}_{SLM}^{j} ( R ) \vert cos ( {ϕ}_{1} ) & if {φ}_{SLM} ( R ) = π\end{matrix}$$

As a consequence, the sign of the difference I^{j,φ1}_{CCD}(R)−I^{j,φ2}_{CCD}(R) indicates if φ_{SLM}(R)=0 or π. Although this method using a phase stepping procedure has been described for a binary wavefront of the reconstructed signal beam, i.e. where φ_{SLM}(R) can only take two different values, this method may be applied for a non-binary wavefront. In this case, more phases φ have to be chosen in order to retrieve the phases of the individual data bits of a phase-modulated data page. This is described in more detail in “Optical Shop Testing”, D. Malacara, ed. , John Wiley & Sons, New York, 1992.

A further method for retrieving the phases of the individual data bits of a phase-modulated data page is described hereinafter. This method does not require a probe signal beam as the methods described hereinbefore. For a same phase-modulated data page, different reconstructed signal beams are detected on the detector 114. This is achieved in that an optical parameter is varied in the holographic read-out device. For example, the focus of the reconstructed signal beam may be varied. The phases of the individual data bits of the phase-modulated data page may be retrieved by a specific analysis of the different signals detected on the detector 114 for the different reconstructed signal beams. Such a method is already known in other technical fields, such as high resolution electron microscopy. This is described, for instance, in “Special Issue of Ultramicroscopy on Brite-Euram Project No. 3322”, “Towards One-Angstrom Resolution”, Ultramicroscopy, Vol. 64, 1996.

The methods for reading out a phase-modulated data page according to the invention can be implemented in integrated circuits intended to be integrated in an holographic device. A set of instructions that is loaded into a program memory causes the integrated circuit to carry out one of the methods for reading out the data page. The set of instructions may be stored on a data carrier such as, for example, a disk. The set of instructions can be read from the data carrier so as to load it into the program memory of the integrated circuit, which will then fulfill its role.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. An optical holographic device for recording a data page in a holographic medium (106), said device comprising means (100) for generating a signal beam, means (201) for modulating the phase of said signal beam so as to encode said data page and means (102, 107, 108) for interfering said modulated signal beam with a reference beam inside said holographic medium.

2. An optical holographic device as claimed in claim 1, further comprising means (103) for modulating the amplitude of said signal beam.

3. A holographic medium comprising at least one phase-modulated data page.

4. A holographic medium as claimed in claim 3, further comprising at least one amplitude-modulated data page.

5. A holographic device for reading out a holographic medium as claimed in claim 3, said holographic device comprising means (401, 402, 114, 403) for retrieving phases of individual data bits of the phase-modulated data page.

6. A holographic device as claimed in claim 5, said device comprising means (100, 102) for generating a reference signal, means (109, 111, 112, 113) for directing said reference signal towards said holographic medium so as to generate a phase-modulated reconstructed signal beam, means (114) for detecting said phase-modulated reconstructed signal beam, means (401) for generating a probe signal and means (402) for interfering said probe signal with the phase-modulated reconstructed signal beam before the latter reaches the detecting means.

7. A holographic device as claimed in claim 6, further comprising means for calculating a Fourier transform of a signal detected on the detecting means, said Fourier transform comprising a central band and two side-bands, and means for calculating a backward Fourier transform of at least one of the side-bands so as to retrieve phases of individual data bits of the phase-modulated data page.

8. A holographic device as claimed in claim 6, further comprising means for varying the phase of said probe signal so as to retrieve the phases of individual data bits of the phase-modulated data page by means of a phase stepping procedure.

9. A method for reading out a holographic medium as claimed in claim 3, said method comprising a step of retrieving phases of individual data bits of the phase-modulated data page.

10. A computer program comprising a set of instructions which, when loaded into a processor or a computer, causes the processor or the computer to carry out the method as claimed in claim 9.
